(19) United States
(12) Patent Application Publication
(10) Pub. No.: US 2025/0110421 A1
(43) Pub. Date: Apr. 3, 2025

(54) IMAGE FORMING APPARATUS, NON-TRANSITORY COMPUTER READABLE MEDIUM AND IMAGE FORMING METHOD

(71) Applicant: FUJIFILM Business Innovation Corp., Tokyo (JP)

(72) Inventors: Motoki MATSUSHIMA, Kanagawa (JP); Yu TSUDA, Kanagawa (JP); Yuji KIKUCHI, Kanagawa (JP)

(73) Assignee: FUJIFILM Business Innovation Corp., Tokyo (JP)

(21) Appl. No.: 18/591,124

(22) Filed: Feb. 29, 2024

(30) Foreign Application Priority Data
Sep. 28, 2023 (JP) 2023-168621

(51) Int. Cl. G03G 15/08; G03G 15/00

(52) U.S. Cl. CPC G03G 15/0808; G03G 15/5008; G03G 2215/0106

(57) ABSTRACT

An image forming apparatus is enabled to perform a first operation that forms an image with a first developer of one color transported by a first transport unit and held by a first developer holder that is rotating and a second operation that forms an image with a second developer of another color transported by a second transport unit and held by a second developer holder that is rotating. In the first operation, a rotational speed of the first developer holder and a rotational speed of the second developer holder are a first rotational speed and a transport speed of the first developer transported by the first transport unit and a transport speed of the second developer transported by the second transport unit are a first transport speed, and in the second operation, the rotational speed of the first developer holder and the rotational speed of the second developer holder are a second rotational speed lower than the first rotational speed, the transport speed of the first developer transported by the first transport unit is a second transport speed lower than the first transport speed and the transport speed of the second developer transported by the second transport unit is higher than the second transport speed.

### CROSS-REFERENCE TO RELATED APPLICATIONS

This application is based on and claims priority under 35 USC 119 from Japanese Patent Application No. 2023-168621 filed Sep. 28, 2023.

### BACKGROUND

### (i) Technical Field

The present disclosure relates to an image forming apparatus, a non-transitory computer readable medium and an image forming method.

### (ii) Related Art

Japanese Unexamined Patent Application Publication No. 2010-151974 discloses an image forming apparatus that includes an image carrier, color developing part and transparent developing part. The image carrier is rotationally driven and has a latent image formed on a surface thereof in response to image information. The color developing part develops an image from the latent image formed on the image carrier while admixing with an admixer a two-component developer containing color toner and carrier. The transparent developing part develops an image from the latent image formed on the image carrier while admixing a two-component developer containing transparent toner and carrier with an admixer having a lower admixing power than the admixer of the color developing part.

### SUMMARY

In an image forming apparatus enabled to perform a first operation that forms an image with a first developer of one color transported by a first transport unit and held by a first developer holder that is rotating and a second operation that forms an image with a second developer of another color transported by a second transport unit and held by a second developer holder that is rotating, the case in which a rotational speed of the first developer holder and a rotational speed of the second developer holder in the second operation fall below the corresponding rotational speeds in the first operation may now be contemplated. In response to the fall in the rotational speeds in the second operation, a transport speed of the first transport unit and a transport speed of the second transport unit may fall below the corresponding transport speeds in the first operation. In such a case, if the second developer is more difficult to charge than the first developer, the second developer at a lower charge amount may be supplied to the second development holder.

Aspects of non-limiting embodiments of the present disclosure relate to controlling a reduction in an amount of charge of the second developer in comparison with the case where the transport speed of the second transport unit transporting the second developer becomes lower than in the first operation if the rotational speed of the first developer holder and the rotational speed of the second developer holder in the second operation become lower than in the first operation.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus enabled to perform a first operation that forms an image with a first developer of one color transported by a first transport unit and held by a first developer holder that is rotating and a second operation that forms an image with a second developer of another color transported by a second transport unit and held by a second developer holder that is rotating, wherein in the first operation, a rotational speed of the first developer holder and a rotational speed of the second developer holder are a first rotational speed and a transport speed of the first developer transported by the first transport unit and a transport speed of the second developer transported by the second transport unit are a first transport speed, and wherein in the second operation, the rotational speed of the first developer holder and the rotational speed of the second developer holder are a second rotational speed lower than the first rotational speed, the transport speed of the first developer transported by the first transport unit is a second transport speed lower than the first transport speed and the transport speed of the second developer transported by the second transport unit is higher than the second transport speed.

### BRIEF DESCRIPTION OF THE DRAWINGS

Exemplary embodiments of the present disclosure will be described in detail based on the following figures, wherein:

FIG. 1 illustrates an image forming apparatus;

FIG. 2 illustrates a developing part in the image forming apparatus;

FIGS. 3A and 3B illustrate developing parts in the image forming apparatus of a first exemplary embodiment wherein FIG. 3A illustrates one developing part and FIG. 3B illustrates another developing part;

FIG. 4 illustrates a hardware configuration of a controller in the image forming apparatus;

FIG. 5 is a block diagram illustrating a functional configuration of a controller of the first exemplary embodiment;

FIG. 6 is a flowchart illustrating a process of speed control of a transport unit of the developing part when a print job is received in the first exemplary embodiment;

FIG. 7 is a table illustrating an example of speeds of the developing parts of the first exemplary embodiment;

FIGS. 8A and 8B illustrate developing parts in the image forming apparatus of a second exemplary embodiment wherein FIG. 3A illustrates one developing part and FIG. 3B illustrates another developing part;

FIG. 9 is a block diagram illustrating a functional configuration of a controller of the second exemplary embodiment;

FIG. 10 is a flowchart illustrating a process of speed control of a transport unit of the developing part when a print job is received in the second exemplary embodiment; and

FIG. 11 is a table illustrating an example of speeds of the developing parts of the second exemplary embodiment.

### DETAILED DESCRIPTION

Exemplary embodiments of the disclosure are described below in detail with reference to the drawings.

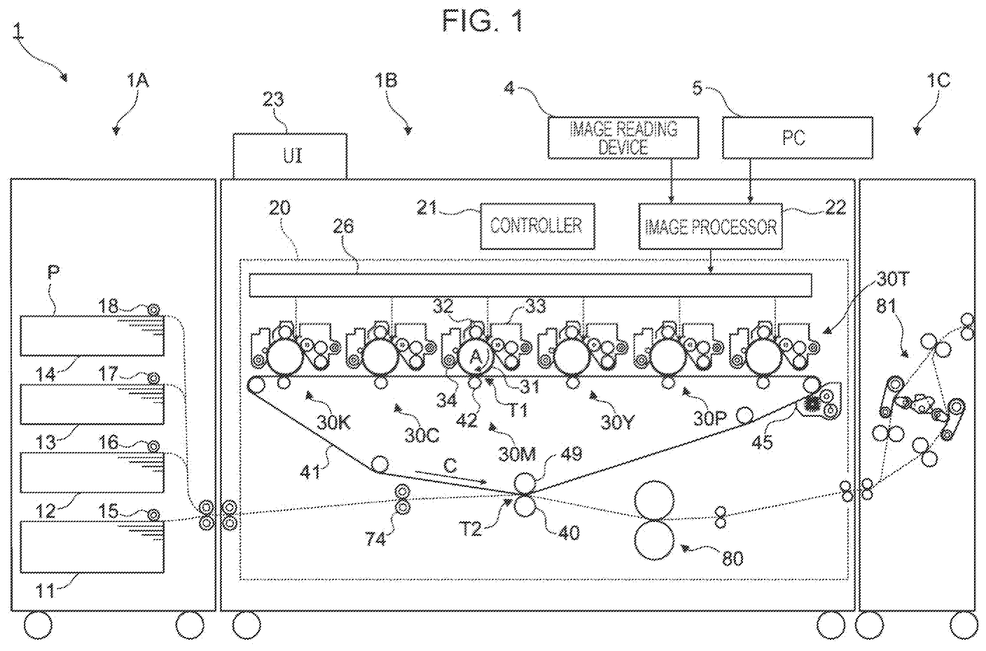

FIG. 1 illustrates an image forming apparatus 1.

The image forming apparatus 1 of the exemplary embodiments includes a paper feeder module 1A, printing module 1B and copy receiving module 1C.

The paper feeder module 1A includes first paper trays 11 through fourth paper tray 14 containing paper sheets P serving as an example of a recording medium.

The paper feeder module 1A includes paper feed rollers 15 through 18 that are respectively arranged for the first paper tray 11 through fourth paper tray 14 and feed paper sheets P contained in the paper trays to a transport path connected to the printing module 1B.

The printing module 1B includes an image former 20 that forms an image on a paper sheet P. The printing module 1B also includes the controller 21 that controls elements of the image forming apparatus 1.

The printing module 1B includes an image processor 22. The image processor 22 performs image processing on image data transmitted from an image reading device 4 or a personal computer (PC) 5.

The printing module 1B includes a touch panel and a user interface (UI) 23 that notifies a user of information and receives information from the user.

The image former 20 includes six image forming units 30T, 30P, 30Y, 30M, 30C and 30K (hereinafter occasionally simply referred to as an “image forming unit 30”) that are arranged in parallel with fixed space intervals therebetween.

Each image forming unit 30 includes a photoconductor drum 31 that rotates in the direction denoted by an arrow A with a latent image being formed thereon, charging roller 32 that charges the surface of the photoconductor drum 31, developing part 33 that develops an image from the latent image formed on the photoconductor drum 31 and a drum cleaner 34 that removes toner and the like from the surface of the photoconductor drum 31.

The image former 20 also includes a laser exposure device 26 that exposes to laser light the photoconductor drum 31 of each image forming unit 30.

The light exposure of the photoconductor drum 31 using the laser exposure device 26 is not limited to laser light. For example, each image forming unit 30 may include a light source, such as a light emitting diode (LED), and the photoconductor drum 31 may be exposed to light emitted from the light source.

The image forming units 30 are identical in configuration to each other except toner contained in the developing part 33. The image forming units 30Y, 30M, 30C and 30K respectively form yellow (Y), magenta (M), cyan (C) and black (K) toner images.

The image forming units 30T and 30P form toner images using toner corresponding to a corporate color, foaming toner for braille, fluorescent toner and toner enhancing gloss. In other words, the image forming units 30T and 30P form toner images using special color toner.

The image former 20 also includes an intermediate transfer belt 41 to which the toner images of the colors formed on the photoconductor drums 31 of the image forming units 30 are transferred.

The image former 20 further includes first transfer rollers 42 that transfer the toner images of the colors of the image forming units 30 to the intermediate transfer belt 41 at first transfer sections T1.

The image former 20 further includes a second transfer roller 40 that transfers at a time a toner image on the intermediate transfer belt 41 to the paper sheet P at a second transfer section T2.

The image former 20 further includes a belt cleaner 45 that removes the toner and the like on the surface of the intermediate transfer belt 41 and a fixing device 80 that fixes the second-transferred image onto the paper sheet P.

The developing part 33 is an example of a development unit, the intermediate transfer belt 41 is an example of a transfer unit and the fixing device 80 is an example of a fixing unit.

The image former 20 performs an image forming operation in accordance with a control signal from the controller 21.

Specifically, in the image former 20, the image processor 22 performs the image processing operation on image data input from the image reading device 4 or PC 5 and supplies the processed image data to the laser exposure device 26.

With the surface of the photoconductor drum 31 in the magenta (M) image forming unit 30M charged with the charging roller 32, the laser exposure device 26 irradiates the photoconductor drum 31 with image-data-modulated laser light that is received from the image processor 22.

A latent image is thus formed on the photoconductor drum 31.

The latent image thus formed is developed by the developing part 33 into a magenta toner image on the photoconductor drum 31.

Similarly, yellow, cyan and black toner images are respectively formed on the image forming units 30Y, 30C and 30K and the special color toner images are formed on the image forming units 30T and 30P.

The toner images formed on the image forming units 30 are successively electrostatically transferred to the intermediate transfer belt 41 moving in the direction of the arrow C in FIG. 1 by the first transfer rollers 42, leading to a toner image superimposed on the intermediate transfer belt 41.

With the intermediate transfer belt 41 moving, the toner image superimposed on the intermediate transfer belt 41 is transported to the second transfer section T2 including the second transfer roller 40 and backup roller 49.

The paper sheet P is picked up from the first paper tray 11 by a feeder roller 15 and then transported along the transport path to the position of a paper stop roller 74.

When the superimposed toner image reaches the second transfer section T2, the paper sheet P is transported to the second transfer section T2 from the paper stop roller 74.

The effect of a transfer electric field created at the second transfer section T2 between the second transfer roller 40 and backup roller 49 causes the superimposed toner image to be electrostatically transferred to the paper sheet P.

The paper sheet P having the superimposed toner image transferred thereto is transported to the fixing device 80.

The fixing device 80 presses and heats the paper sheet P having the unfixed toner image, thereby performing a fixing operation to fix the toner image onto the paper sheet P.

The paper sheet P having undergone the fixing operation is transported via a curl correction section 81 in the copy receiving module IC and then discharged into a paper receiving tray (not illustrated).

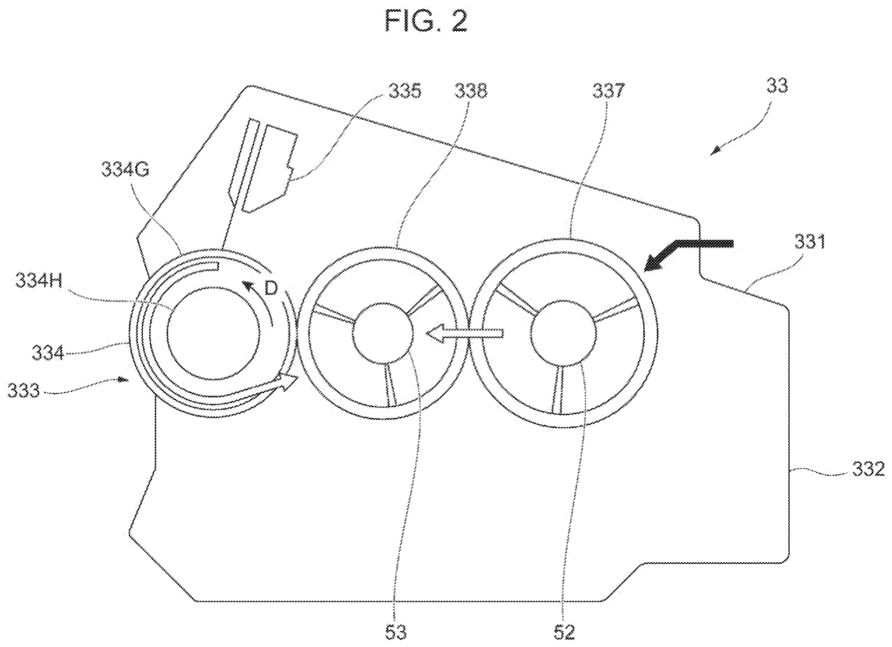

FIG. 2 is a side view of the developing part 33 of the image forming apparatus 1 viewed from the same direction indicated in FIG. 1.

Referring to FIG. 2, the developing part 33 includes a container 331 containing developer (not illustrated). The container 331 includes a container housing 332 that is made of resin. The developer is a two-component developer including magnetic carrier and color toner. The developer may be a one-component developer.

A container body 332 of the developing part 33 is arranged to extend in a direction perpendicular to the plane of the page of FIG. 2, namely in a direction from a front side to a rear side of the image forming apparatus 1 (see FIG. 1), and includes a front-side member (not illustrated) on the front side and a rear-side member (not illustrated) on the rear side.

The container body 332 includes an opening 333 at a location facing the photoconductor drum 31 (see FIG. 1). A developing roller 334 that causes the developer to stick to the surface of the photoconductor drum 31 is arranged in the opening 333. The developing roller 334 holds the developer that is to be applied to the photoconductor drum 31. A position where the developer of the developing roller 334 is supplied to the photoconductor drum 31 may be referred to as a developing position.

The developing roller 334 is cylindrical and arranged to extend in the direction from the front side to the rear side of the image forming apparatus 1. In other words, the developing roller 334 is arranged to extend in the longitudinal direction of the developing part 33.

The developing roller 334 includes a developing sleeve 334G that is a cylindrical body and performs rotary drive and a magnetic roller 334H arranged inside the developing sleeve 334G.

The developing sleeve 334G is manufactured of, for example, stainless used steel (SUS). The developing sleeve 334G rotates in the direction denoted by the arrow D.

According to the exemplary embodiments, the developing sleeve 334G and the photoconductor drum 31 rotate in a synchronous direction at the first transfer section T1 (see FIG. 1) between the developing roller 334 and the photoconductor drum 31.

The developing part 33 includes a layer thickness regulating member 335 that regulates a thickness of the developer held by the developing roller 334.

Referring to FIG. 2, the developing part 33 includes first transport unit 337 and second transport unit 338 that transport the developer. In the following discussion, the first transport unit 337 and the second transport unit 338 may also referred to transport units 337-338.

The transport units 337-338 are arranged on the opposite side of the developing roller 334 with respect to the photoconductor drum 31 (see FIG. 1).

The transport units 337-338 have respectively rotary members 52 and 53 that extend along an axis of rotation of the developing sleeve 334G that performs rotary drive and the transport units 337 and 338 thus respectively rotate on the rotary members 52-53. The transport units 337-338 are thus arranged in parallel with the photoconductor drum 31 (see FIG. 1).

The rotary member 52 is an admix auger admixing the developer and the rotary member 53 is a supply auger that supplies the developer to the developing roller 334.

Rotational speeds of the developing roller 334 and the rotary members 52-53 in each developing part 33 when a special color toner image is formed by the image forming unit 30 or when the special color toner image is not formed by the image forming unit 30 are described below. The rotational speed of the rotary members 52-53 may also be referred to as the speed of the transport units 337-338.

First and second exemplary embodiments are described below.

### First Exemplary Embodiment

First exemplary embodiment is described below.

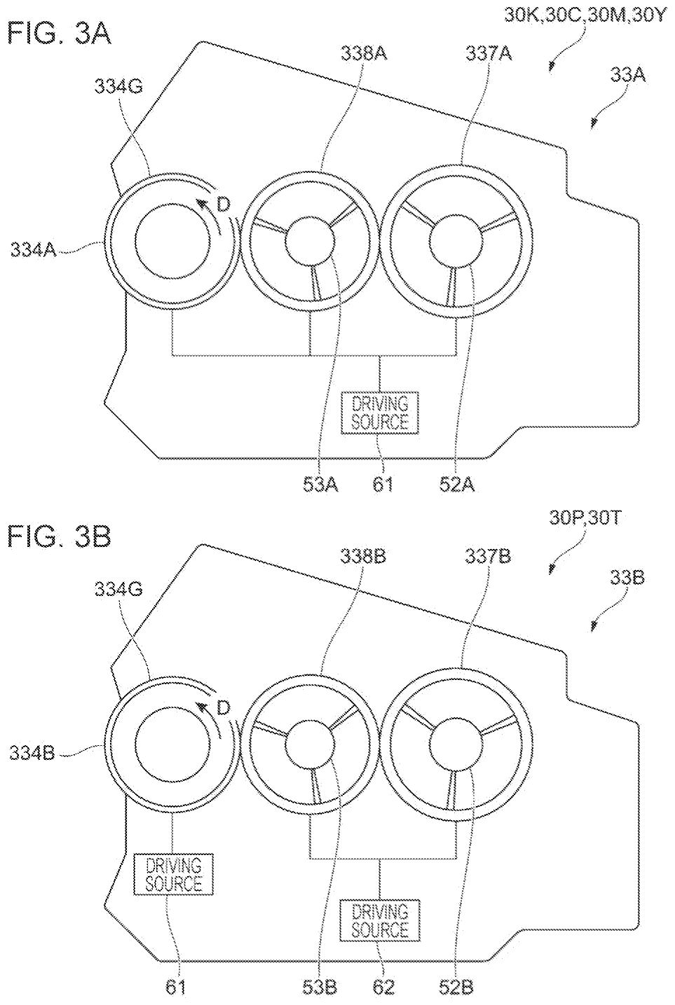

FIGS. 3A and 3B illustrate developing parts 33A and 33B in the image forming apparatus 1 of the first exemplary embodiment. FIG. 3A illustrates the developing part 33A and FIG. 3B illustrates another developing part 33B.

The developing parts 33A and 33B are basically identical in configuration to each other but every component in each part is designated with a corresponding symbol that indicates which part the component belongs to. For example, a component in the developing part 33A is suffixed with “A” and a component in the developing part 33B is suffixed with “B.” Some components described with reference to FIG. 2 may not be described again or omitted from FIGS. 3A and 3B.

The developing parts 33A illustrated in FIG. 3A respectively included in the image forming units 30Y, 30M, 30C and 30K, from among the image forming units 30Y, 30M, 30C, 30K, 30P and 30T (see FIG. 1), respectively form yellow, magenta, cyan and black toner images. The developing parts 33B illustrated in FIG. 3B respectively included in the image forming units 30P and 30T form special color toner images.

Furthermore, as illustrated in FIG. 3A, the developing sleeve 334G of the developing roller 334A and the respective rotary members 52A-53A of the transport units 337A-338A in the developing part 33A are driven by the driving source 61.

As illustrated in FIG. 3B, the developing sleeve 334G of the developing roller 334B is driven by the driving source 61 in the developing part 33B, and on the other hand, the respective rotary members 52B-53B of the transport units 337B-338B in the developing part 33B are rotationally driven by the driving source 62 different from the driving source 61.

The rotational speed of the developing roller 334A and the rotary members 52A-53A of the transport units 337A-338A in the developing part 33A and the rotational speed of the developing roller 334B in the developing part 33B are different at a predetermined ratio. The rotary members 52B-53B of the transport units 337B-338B in the developing part 33B and the rotary members 52A-53A of the transport units 337A-338A in the developing part 33A are rotatable at a different ratio.

The driving source 61 illustrated in FIG. 3B drives the developing roller 334B and is an example of a driving source that rotates a second developer holder. The driving source 62 illustrated in FIG. 3B drives the rotary members 52B-53B of the transport units 337B-338B and is an example of another driving source that drives a second rotary member.

According to the first exemplary embodiment, the developing part 33B includes two driving sources 61 and 62 but the driving source 62 driving the rotary members 52B-53B may be deleted and the rotary members 52B-53B may be driven by the driving source 61. Specifically, the driving source 61 may include a reduction gear and drive the rotary members 52B-53B at a different speed.

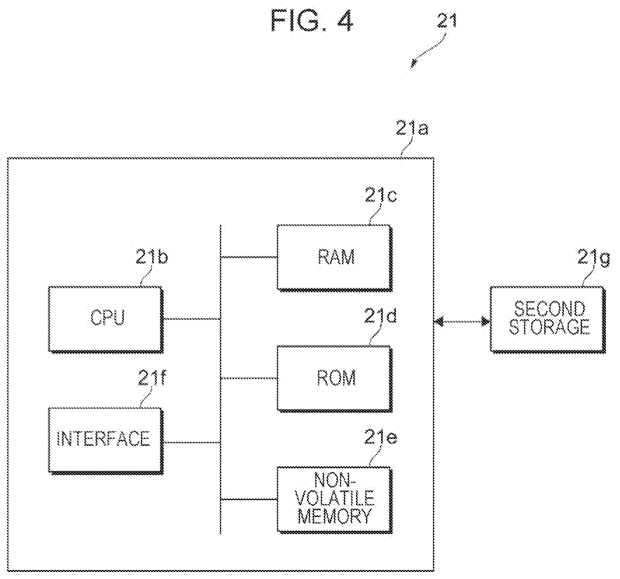

FIG. 4 illustrates a hardware configuration of the controller 21 in the image forming apparatus 1. The controller 21 in the image forming apparatus 1 is implemented by a computer.

The controller 21 includes an arithmetic processing unit 21a that performs a digital arithmetic processing operation in accordance with a program and a second storage 21g that stores information.

The second storage 21g may be an available information storage device, such as a hard disk drive (HDD), semiconductor memory or magnetic tape.

The arithmetic processing unit 21a includes a central processing unit (CPU) 21b as a processor.

The arithmetic processing unit 21a also includes a random-access memory (RAM) 21c that is used as a working memory for the CPU 21b and read-only memory (ROM) 21d that stores a program and the like performed by the CPU 21b.

The arithmetic processing unit 21a further includes a non-volatile memory 21e that is configured to be re-writable and continues to store data even when power supplying is interrupted and an interface 21f that controls a communication unit connected to the arithmetic processing unit 21a.

The non-volatile memory 21e includes a static SRAM backed up by a battery or a flash memory. The second storage 21g stores not only files but also a program executed by the arithmetic processing unit 21a.

According to the first exemplary embodiment, the arithmetic processing unit 21a performs operations by reading programs stored on the ROM 21d or the second storage 21g.

The programs to be executed by the CPU 21b may be delivered to the image forming apparatus 1 in a recorded form on one of computer readable recording media including a magnetic recording medium (such as a magnetic tape or magnetic disk), optical recording medium (such as an optical disk), magneto-optical recording medium or semiconductor memory. The programs to be executed by the CPU 21b may also be delivered to the image forming apparatus 1 using a communication medium, such as the Internet.

In the exemplary embodiments, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiments, the term “processor” is broad enough to encompass one processor or plural processors in collaboration which are located physically apart from each other but may work cooperatively. The order of operations of the processor is not limited to one described in the embodiments below, and may be changed.

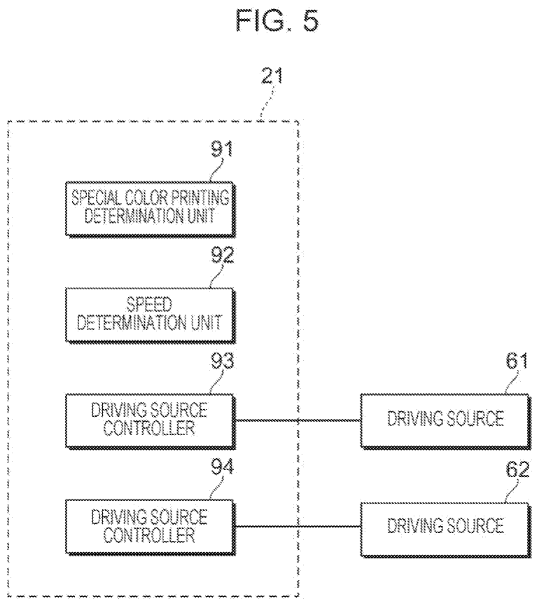

FIG. 5 is a block diagram illustrating a functional configuration of the controller 21 of the first exemplary embodiment.

Referring to FIG. 5, the controller 21 includes a special color printing determination unit 91, speed determination unit 92 and driving source controllers 93 and 94. These elements including the special color printing determination unit 91 are implemented by the CPU 21b (see FIG. 4).

The driving sources 61 and 62 external to the controller 21 in FIG. 5 are respectively the driving sources 61 and 62 described with reference to FIGS. 3A and 3B.

The special color printing determination unit 91 determines whether a print job received by the image forming apparatus I forms a special color toner image. Specifically, the special color printing determination unit 91 determines whether a toner image of yellow (Y), magenta (M), cyan (C) and black (K) with no special color image is formed or the image of the YMCK colors and the special color image are formed.

Depending on whether the special color printing using the special color toner is performed, the speed determination unit 92 determines the speed of the rotary members 52B-53B of the transport units 337B-338B in the developing part 33B. The speed corresponds to a maximum paper per minute (paper per minute: ppm), namely, is a process speed. The speed is not limited to the process speed. The speed may be a specific rotational speed of the rotary members 52B-53B.

Specifically, if information indicating a predetermined speed for the special color printing is stored on the ROM 21d (see FIG. 4), the speed determination unit 92 reads, as a speed to be determined, information indicating the speed from the ROM 21d when the determination result of the special color printing determination unit 91 indicates the special color printing.

The speed of the transport units 337B-338B with the special color printing not performed is a predetermined ordinary speed that is not determined by the speed determination unit 92. Alternatively, the speed of the transport units 337B-338B may be determined by the speed determination unit 92.

Furthermore, the speed of the developing roller 334A and the transport units 337A-338A in the developing part 33A and the speed of the developing roller 334B in the developing part 33B are not determined by the speed determination unit 92 and are the same predetermined speed regardless of whether or not printing is the special color printing. The disclosure is not limited to this setting. For example, if the speeds of the developing rollers 334A and 334B and the transport units 337A-338A become different depending on whether the printing is the special color printing, the speed determination unit 92 may determine these speeds in response to whether or not the printing is the special color printing.

The driving source controller 93 controls the driving source 61. Specifically, the driving source controller 93 controls the driving source 61 such that the developing rollers 334A and 334B and the transport units 337A-338A rotate at predetermined speeds.

The driving source controller 94 controls the driving source 62. Specifically, the driving source controller 94 controls the driving source 62 such that the transport units 337B-338B move at a speed determined by the speed determination unit 92.

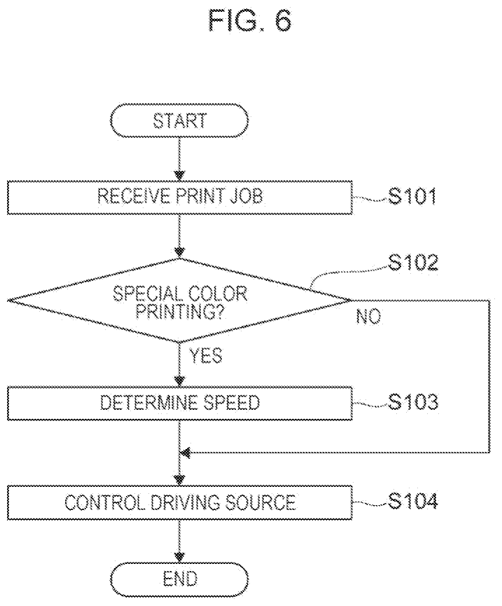

FIG. 6 is a flowchart illustrating a process of speed control of the transport units 337B-338B in the developing part 33B when a print job is received in the first exemplary embodiment.

When the print job is received in the image forming apparatus 1 in the example in FIG. 6 (step S101), the special color printing determination unit 91 (see FIG. 4) determines whether the received print job is the special color printing using a special color toner (step S102).

If the received print job is the special color printing (yes in step S102), the speed determination unit 92 (see FIG. 4) determines in step S103 the speed of the transport units 337B-338B in the developing part 33B (see FIG. 3B).

When the image former 20 (see FIG. 1) starts operating after the determination of the speeds, the developing rollers 334A and 334B and the transport units 337A-338A and 337B-338B start rotating. The driving source controller 94 controls the driving source 62 such that the transport units 337B-338B rotate at the determined speed (step S104). The speed of the transport units 337B-338B is not varied until the end of printing. In other words, the speed of the transport units 337B-338B is not varied from the start until the end of the rotation of the developing rollers 334A and 334B.

If the print job is not the special color printing (no in step S102), the driving source controller 94 controls the driving source 62 such that the transport units 337B-338B in the developing part 33B rotate at a predetermined speed (step S104).

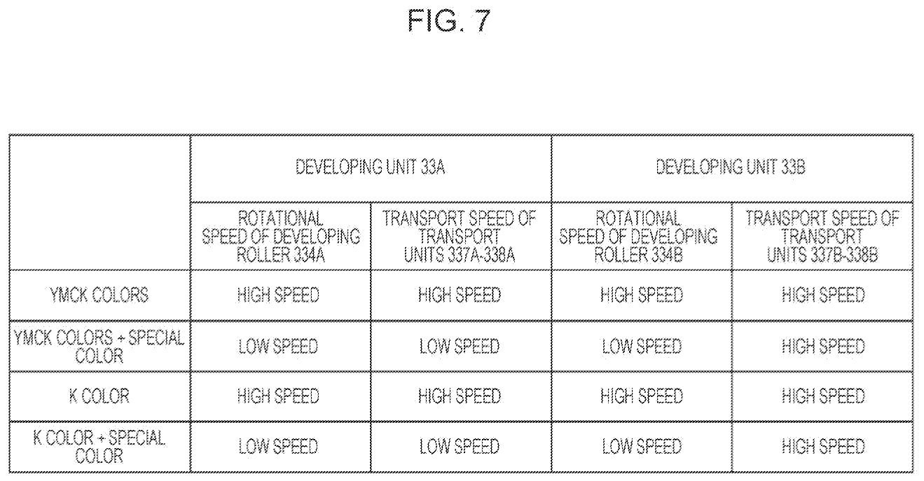

FIG. 7 is a table illustrating an example of the rotational speeds and the transport speeds of the developing parts 33A and 33B of the first exemplary embodiment.

The table illustrated in FIG. 7 lists the rotational speeds and transport speeds of the developing parts 33A and 33B at each of column items of YMCK colors, YMCK colors+special color, K color, and K color+special color.

The rotational speed of the developing roller 334A in the developing part 33A matches the rotational speed of the photoconductor drum 31 that is supplied with the developer by the developing roller 334A and the rotational speed of the developing roller 334B in the developing part 33B matches the rotational speed of the photoconductor drum 31 that is supplied with the developer by the developing roller 334B.

The transport speed of the transport units 337A-338A in the developing part 33A matches the rotational speed of the rotary members 52A-53A and the transport speed of the transport units 337B-338B in the developing part 33B matches the rotational speed of the rotary members 52B-53B.

Referring to FIG. 7, the rotational speed is categorized into “high speed” and “low speed” and the transport speed is categorized into “high speed” and “low speed.” The high speed and low speed of the rotational speed refers to the magnitude level of speed and the high speed and low speed of the transport speed also refers to the magnitude level of speed. As an example of the rotational speed, if the high speed is 85 ppm (ppm indicating the maximum number of sheets per minute), the low speed is 40 ppm.

A high speed of the rotational speed and a high speed of the transport speed may be equal to each other or different from each other. Similarly, a low speed of the rotational speed and a high speed of the transport speed may be equal to each other or different from each other.

If the YMCK colors are used without the special color printing, the rotational speed of the developing roller 334A and the transport speed of the transport units 337A-338A in the developing part 33A and the rotational speed of the developing roller 334B and the transport speed of the transport units 337B-338B in the developing part 33B are all high.

If golden toner or silver toner, containing aluminum particles or white toner involving a lot of developer pigment is used as special color toner, fixing temperature is to be raised to meet glossiness. If the YMCK colors and the special color are used, the speed of each of the developing rollers 334A and 334B and the transport units 337A-338A is low to ensure higher fixing temperature while the speed of each of the transport units 337B-338B is high. In other words, when the special color printing is performed on the image forming units 30T and 30P, each having the developing part 33B, the speed of the rotary members 52B-53B of the transport units 337B-338B is not reduced if the photoconductor drum 31 (see FIG. 1) and the developing roller 334B (see FIG. 3B) are set to be lower in speed than when the special color printing is not performed.

This arrangement may control a reduction that, when the transport speed of the transport units 337B-338B decreases, is caused in an amount of charge of the developer containing a special color toner admixed and transported by the transport units 337B-338B in the developing part 33B.

Specifically, when the special color printing is performed, the rotational speed of the developing roller 334A and the rotational speed of the developing roller 334B may decrease. In such a case, the reduction in the amount of charge of the developer for the special color printing may be controlled by setting a decrease in the transport speed of the transport units 337B-338B transporting the developer for the special color printing to be smaller than a decrease in the rotational speed of the developing roller 334B.

If the K color is used without the special color printing, the rotational speed of the developing rollers 334A and 334B and the transport speed of the transport units 337A-338A and 337B-338B are high in the same way as the YMCK colors are used. If the K color is used with the special color printing, the rotational speeds of the developing rollers 334A and 334B and the transport speed of the transport units 337A-338A are low while the transport speed of the transport units 337B-338B are high in the same way as the YMCK colors are used with the special color printing.

Referring to FIG. 7, concerning the special color printing, the speed of the rotary members 52B-53B with the developing roller 334B rotating at the low speed is high and thus higher than the speed of the rotary members 52A-53A with the developing roller 334A rotating at the low speed.

Referring to FIG. 7, concerning the printing with no special color, the rotary members 52B-53B rotate at the high speed with the developing roller 334B rotating at the high speed. Specifically, the high speed at which the rotary members 52B-53B rotate with the developing roller 334B rotating at the high speed with the printing with no special color is equal to the speed of the rotary members 52B-53B with the developing roller 334B rotating at the low speed with the special color printing.

Referring to FIG. 3, the developing roller 334A in the developing part 33A is an example of a rotating first developer holder and the developing roller 334B in the developing part 33B is an example of a rotating second developer holder. The transport units 337A-338A in the developing part 33A are an example of a first transport unit and the transport units 337B-338B in the developing part 33B are an example of a second transport unit. A YMCK color developer is an example of a first developer and a special color developer is an example of a second developer.

The driving source 61 is an example of a driving source that rotates the second developer holder and the driving source 62 is an example of a different driving source.

Referring to FIG. 7, the “high speed” as the rotational speed is an example of a first rotational speed and the “low speed” as the rotational speed is an example of a second rotational speed. Referring to FIG. 7, the “high speed” as the transport speed is an example of a first transport speed and the “low speed” as the transport speed is an example of a second transport speed.

### Second Exemplary Embodiment

Second exemplary embodiment is described below. According to the second exemplary embodiment, the configuration of the image forming units 30Y, 30M, 30C and 30K is identical to the configuration of the first exemplary embodiment (see FIG. 3A) while the configuration of the image forming units 30T and 30P is different the configuration of the first exemplary embodiment (see FIG. 3B). The difference is specifically described.

The discussion of the configuration and control method of the second exemplary embodiment identical to those in the first exemplary embodiment is occasionally omitted.

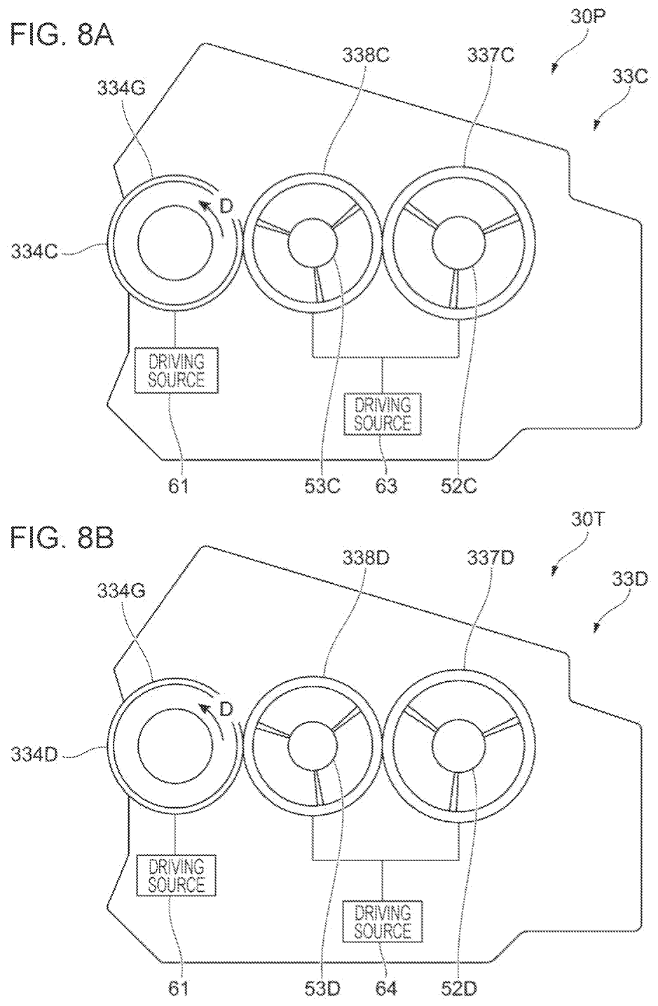

FIGS. 8A and 8B illustrate developing parts 33C and 33D in the image forming apparatus 1 of the second exemplary embodiment. FIG. 8A illustrates the developing part 33C and FIG. 8B illustrates the developing part 33D. FIGS. 8A and 8B correspond to FIGS. 3A and 3B illustrating the first exemplary embodiment.

According to the second exemplary embodiment, the developing part 33A described with reference to the first exemplary embodiment (see FIG. 3A) is employed but the developing part 33B described with reference to the first exemplary embodiment is replaced with developing parts 33C and 33D. Specifically, the second exemplary embodiment includes the developing parts 33A, 33C and 33D.

The developing parts 33C and 33D are identical in configuration to the developing part 33B (see FIG. 3B) but every component in each part is designated with a corresponding symbol that indicates which part the component belongs to. For example, a component in the developing part 33C is suffixed with “C” and a component in the developing part 33D is suffixed with “D.”

The developing part 33C illustrated in FIG. 8A is included in the image forming unit 30P and forms a toner image of a special color. The developing part 33D illustrated in FIG. 8B is included in the image forming unit 30T and forms a toner image of a specific color.

In the developing part 33C as illustrated in FIG. 8A, a developing sleeve 334G of a developing roller 334C is rotationally driven by a driving source 61 while rotary members 52C and 53C of transport units 337C and 338C are rotationally driven by a driving source 63 different from the driving source 61.

In the developing part 33D as illustrated in FIG. 8B, a developing sleeve 334G of a developing roller 334D is rotationally driven by the driving source 61 while rotary members 52D and 53D of transport units 337D and 338D are rotationally driven by a driving source 64 different from the driving source 61.

The developing roller 334C in the developing part 33C and the developing roller 334D in the developing part 33D rotate at the same speed. The speed of the developing roller 334C and the developing roller 334D is the same speed as the speed of the developing roller 334A and the rotary members 52A-53A of the transport units 337A-338A in the developing part 33A (see FIG. 3A).

The rotary members 52C-53C of the transport units 337C-338C in the developing part 33C are rotatable at a speed different from the speed of the rotary members 52A-53A (see FIG. 3A) in the developing part 33A.

The rotary members 52D-53D of the transport units 337D-338D in the developing part 33D are rotatable at a speed different from the speed of the rotary members 52A-53A (see FIG. 3A) in the developing part 33A and rotatable at a speed different from the speed of the rotary members 52C-53C in the developing part 33C.

The driving source 63 illustrated in FIG. 8A drives the rotary members 52C-53C of the transport units 337C-338C and is an example of a different driving source that drives a second rotary member. The driving source 64 illustrated in FIG. 8B drives the rotary members 52D-53D of the transport units 337D-338D and is an example of the second rotary member.

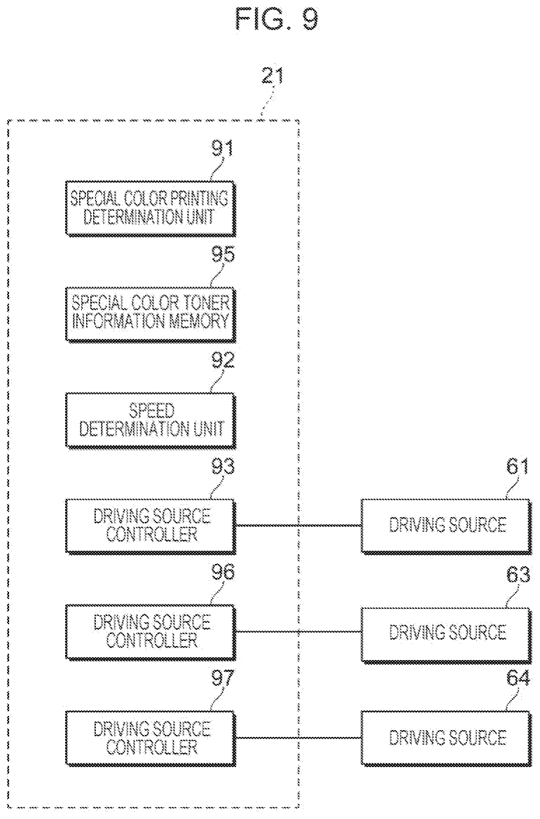

FIG. 9 is a block diagram illustrating a functional configuration of the controller 21 of the second exemplary embodiment and corresponds to FIG. 5 illustrating the first exemplary embodiment. The explanation of components in FIG. 9 common to FIG. 5 may be omitted as appropriate.

Referring to FIG. 9, the controller 21 includes the special color printing determination unit 91, special color toner information memory 95, speed determination unit 92 and driving source controllers 93, 96 and 97.

The driving sources 63 and 64 external to the controller 21 illustrated in FIG. 9 are respectively the driving sources 63 and 64 described with reference to FIGS. 8A and 8B.

The special color toner information memory 95 stores special toner information indicating special color toner held by the developing parts 33C and 33D of the image forming units 30P and 30T.

The special toner information is used by the speed determination unit 92 that determines speed. Moreover, the special toner information is used to identify what type of toner the toner of each of the developing parts 33C and 33D is and, the special toner information, for example, indicates golden toner, silver toner, white toner or the like. The speed of each of the rotary members 52C-53C and 52D-53D may be determined in response to toner by using the special toner information.

The special toner information may include a specific toner name or the specific toner name with a physical property value of a toner component. Information indicating the physical property value is an example of information indicating case of charging. A measurement value obtained beforehand in a measurement may be used in place of the information indicating the physical property value.

The special toner information may be information stored on a recording medium (not illustrated) of the developing parts 33C and 33D of the image forming units 30P and 30T.

The driving source controller 96 controls the driving source 63. Specifically, the driving source controller 96 controls the driving source 63 such that the transport units 337C-338C reach a predetermined speed.

The driving source controller 97 controls the driving source 64. Specifically, the driving source controller 97 controls the driving source 64 such that the transport units 337D-338D reach a predetermined speed.

Referring to FIG. 9, the developing roller 334C in the developing part 33C and the developing roller 334D in the developing part 33D are an example of a rotating second developer holder. The transport units 337C-338C in the developing part 33C and the transport units 337D-338D in the developing part 33D are an example of the second developer holder. The driving sources 63 and 64 are an example of the different driving source.

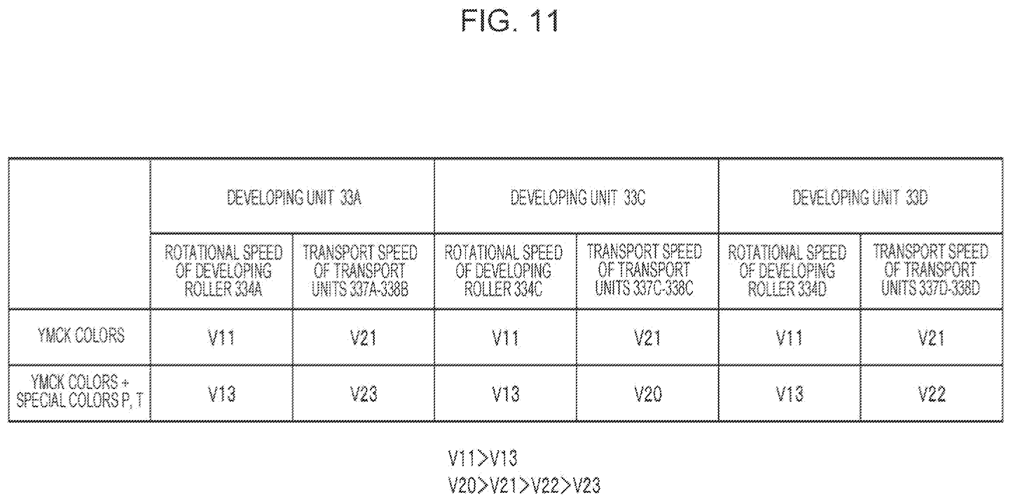

In FIG. 11, “V11” is an example of a first rotational speed and “V13” is an example of a second rotational speed. In FIG. 11, “V21” is an example of a first transport speed and “V23” is an example of a second transport speed. In FIG. 11, “V22” is an example of a transport speed of the second developer lower than the first transport speed and “V20” is an example of a transport speed of the second developer higher than the first transport speed.

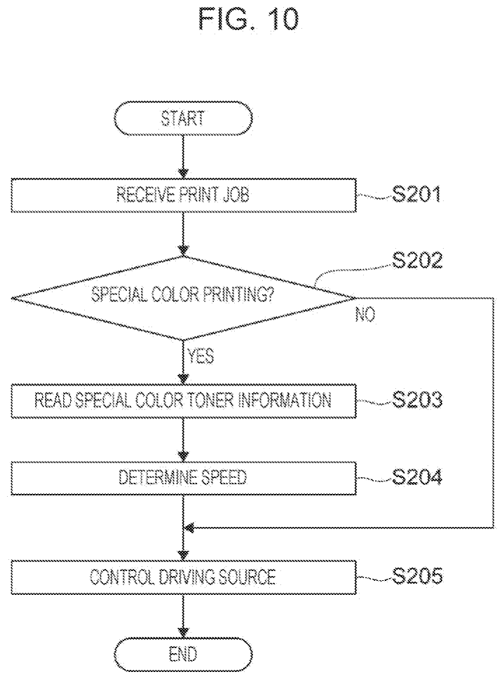

FIG. 10 is a flowchart illustrating a process of speed control of the transport units 337C-338C in the developing part 33C and the transport units 337D-338D in the developing part 33D when the print job is received in the second exemplary embodiment. FIG. 10 corresponds to FIG. 6 illustrating the first exemplary embodiment and the explanation of components in FIG. 10 common to FIG. 6 may be omitted as appropriate.

Referring to FIG. 10, the special color printing determination unit 91 (see FIG. 9) determines whether the received print job is the special color printing using special color toner (steps S201 and S202).

Upon determining that the print job is the special color printing (yes in step S202), the special color printing determination unit 91 reads the special toner information from the special color toner information memory 95 as information on the special color toner to be used for the special color printing (step S203).

In response to the read special toner information, the speed determination unit 92 (see FIG. 9) determines the speed of the transport units 337C-338C (see FIG. 8A) in the developing part 33C and the speed of the transport units 337D-338D (see FIG. 8B) in the developing part 33D (step S204). The driving source controllers 96 and 97 control respectively the driving sources 63 and 64 such that the transport units 337C-338C and the transport units 337D-338D reach respective determined speeds thereof (step S205).

If the print job is not the special color printing (no in step S202), the driving source controllers 96 and 97 control respectively the driving sources 63 and 64 such that the transport units 337C-338C and the transport units 337D-338D reach respective predetermined speeds thereof (step S205).

FIG. 11 is a table listing speeds of the developing parts 33A, 33C and 33D of the second exemplary embodiment and corresponds to FIG. 7 illustrating the first exemplary embodiment. In FIG. 11, in contrast with FIG. 7 listing the rotational speed and transport speed as the high speed or the low speed, the rotational speeds are represented by V11 and V13 and the transport speeds are represented by V20, V21, V22 and V23. The magnitude relationship is V11>V13 and V20>V21>V22>V23. For example, V20 is 85 ppm, V11 and V21 are 80 ppm, V22 is 75 ppm, and V13 and V23 are 40 ppm.

In FIG. 11, special color P is of the special color toner of the developing part 33C and special color T is of the special color toner of the developing part 33D.

The table in FIG. 11 lists the speeds of the developing parts 33A, 33C and 33D for the cases when the YMCK colors are used with or without the special color printing of the special colors P and T.

If the YMCK colors without the special color are used, each of the rotational speeds of the developing roller 334A in the developing part 33A, the developing roller 334C in the developing part 33C and the developing roller 334D in the developing part 33D is V11 and each of the speeds of the transport units 337A-338A in the developing part 33A, the transport units 337C-338C in the developing part 33C and the transport units 337D-338D in the developing part 33D is V21.

On the other hand, if the YMCK colors and the special color P and T are used, the rotational speed of the developing rollers 334A, 334C and 334D is V13 lower than V11 (V11>V13) and the transport speed of the transport units 337A-338A is V23 lower than V21 (V21>V23).

In contrast, the transport speed of the transport units 337C-338C is V20 higher than the transport speed V21 (V20>V21) and the transport speed of the transport units 337D-338D is V22 lower than the speed V21 and higher than the speed V23 (V21>V22>V23). In this way, the transport speed V20 of the transport units 337C-338C and the transport speed V 22 of the transport units 337D-338D are determined based on the speed V21.

According to the second exemplary embodiment, the transport speed of the transport units 337C-338C in the developing part 33C and the transport speed of the transport units 337D-338D in the developing part 33D are set to be different from each other. Since the speed of admixing the special color toner is varied depending on the type of the special color toner, an amount of charge of the special color toner of the developing part 33C and an amount of charge of the special color toner of the developing part 33D may be ensured.

FIG. 11 illustrates the case of the YMCK colors and the special colors P and T. The present disclosure is not limited to this setting. The speeds may be similarly obtained when the YMCK colors and the special color P or the YMCK colors and the special color T are used.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An image forming apparatus enabled to perform a first operation that forms an image with a first developer of one color transported by a first transport unit and held by a first developer holder that is rotating and a second operation that forms an image with a second developer of another color transported by a second transport unit and held by a second developer holder that is rotating,
wherein in the first operation, a rotational speed of the first developer holder and a rotational speed of the second developer holder are a first rotational speed and a transport speed of the first developer transported by the first transport unit and a transport speed of the second developer transported by the second transport unit are a first transport speed, and
wherein in the second operation, the rotational speed of the first developer holder and the rotational speed of the second developer holder are a second rotational speed lower than the first rotational speed, the transport speed of the first developer transported by the first transport unit is a second transport speed lower than the first transport speed and the transport speed of the second developer transported by the second transport unit is higher than the second transport speed.
   (((2)))

In the image forming apparatus according to (((1))), transport of the second developer transported by the second transport unit is driven by a driving source different from a driving source that rotates the second development holder.

(((3)))

In the image forming apparatus according to according to one of (((1))) and (((2))), the transport speed of the second developer transported by the second transport unit in the second operation is determined in accordance with the first transport speed.

(((4)))

In the image forming apparatus according to (((3))), the transport speed of the second developer transported by the second transport unit in the second operation is equal to the first transport speed.

(((5)))

In the image forming apparatus according to (((3))), the transport speed of the second developer transported by the second transport unit in the second operation is lower than the first transport speed.

(((6)))

In the image forming apparatus according to (((3))), the transport speed of the second developer transported by the second transport unit in the second operation is higher than the first transport speed.

(((7)))

In the image forming apparatus according to according to one of (((3))) through (((6))), the transport speed of the first transport unit and the transport speed of the second transport unit are not varied from a start of rotation of the first developer holder and the second developer holder until a stop of the rotation of the first developer holder and the second developer holder.

(((8)))

In the image forming apparatus according to according to one of (((1))) and (((2))), the transport speed of the second developer transported by the second transport unit in the second operation is determined in accordance with the second developer.

(((9)))

In the image forming apparatus according to (((8))), the transport speed of the second developer transported by the second transport unit in the second operation is determined in accordance with information that indicates ease of charging the second developer.

(((10)))

A program causing a computer to execute a process, the computer controlling an image forming apparatus enabled to perform a first operation that forms an image with a first developer of one color transported by a first transport unit and held by a first developer holder that is rotating and a second operation that forms an image with a second developer of another color transported by a second transport unit and held by a second developer holder that is rotating, the process including:
performing the first operation wherein a rotational speed of the first developer holder and a rotational speed of the second developer holder are a first rotational speed and a transport speed of the first developer transported by the first transport unit and a transport speed of the second developer transported by the second transport unit are a first transport speed; and
performing the second operation wherein the rotational speed of the first developer holder and the rotational speed of the second developer holder are a second rotational speed lower than the first rotational speed, the transport speed of the first developer transported by the first transport unit is a second transport speed lower than the first transport speed and the transport speed of the second developer transported by the second transport unit is higher than the second transport speed.

What is claimed is:

1. An image forming apparatus enabled to perform a first operation that forms an image with a first developer of one color transported by a first transport unit and held by a first developer holder that is rotating and a second operation that forms an image with a second developer of another color transported by a second transport unit and held by a second developer holder that is rotating,
wherein in the first operation, a rotational speed of the first developer holder and a rotational speed of the second developer holder are a first rotational speed and a transport speed of the first developer transported by the first transport unit and a transport speed of the second developer transported by the second transport unit are a first transport speed, and
wherein in the second operation, the rotational speed of the first developer holder and the rotational speed of the second developer holder are a second rotational speed lower than the first rotational speed, the transport speed of the first developer transported by the first transport unit is a second transport speed lower than the first transport speed and the transport speed of the second developer transported by the second transport unit is higher than the second transport speed.

2. The image forming apparatus according to claim 1, wherein transport of the second developer transported by the second transport unit is driven by a driving source different from a driving source that rotates the second development holder.

3. The image forming apparatus according to claim 1, wherein the transport speed of the second developer transported by the second transport unit in the second operation is determined in accordance with the first transport speed.

4. The image forming apparatus according to claim 3, wherein the transport speed of the second developer transported by the second transport unit in the second operation is equal to the first transport speed.

5. The image forming apparatus according to claim 3, wherein the transport speed of the second developer transported by the second transport unit in the second operation is lower than the first transport speed.

6. The image forming apparatus according to claim 3, wherein the transport speed of the second developer transported by the second transport unit in the second operation is higher than the first transport speed.

7. The image forming apparatus according to claim 3, wherein the transport speed of the first transport unit and the transport speed of the second transport unit are not varied from a start of rotation of the first developer holder and the second developer holder until a stop of the rotation of the first developer holder and the second developer holder.

8. The image forming apparatus according to claim 1, wherein the transport speed of the second developer transported by the second transport unit in the second operation is determined in accordance with the second developer.

9. The image forming apparatus according to claim 8, wherein the transport speed of the second developer transported by the second transport unit in the second operation is determined in accordance with information that indicates ease of charging the second developer.

10. A non-transitory computer readable medium storing a program causing a computer to execute a process, the computer controlling an image forming apparatus enabled to perform a first operation that forms an image with a first developer of one color transported by a first transport unit and held by a first developer holder that is rotating and a second operation that forms an image with a second developer of another color transported by a second transport unit and held by a second developer holder that is rotating, the process comprising:
performing the first operation wherein a rotational speed of the first developer holder and a rotational speed of the second developer holder are a first rotational speed and a transport speed of the first developer transported by the first transport unit and a transport speed of the second developer transported by the second transport unit are a first transport speed; and
performing the second operation wherein the rotational speed of the first developer holder and the rotational speed of the second developer holder are a second rotational speed lower than the first rotational speed, the transport speed of the first developer transported by the first transport unit is a second transport speed lower than the first transport speed and the transport speed of the second developer transported by the second transport unit is higher than the second transport speed.

11. An image forming method of an image forming apparatus enabled to perform a first operation that forms an image with a first developer of one color transported by a first transport unit and held by a first developer holder that is rotating and a second operation that forms an image with a second developer of another color transported by a second transport unit and held by a second developer holder that is rotating, the image forming method comprising:
performing the first operation wherein a rotational speed of the first developer holder and a rotational speed of the second developer holder are a first rotational speed and a transport speed of the first developer transported by the first transport unit and a transport speed of the second developer transported by the second transport unit are a first transport speed; and
performing the second operation wherein the rotational speed of the first developer holder and the rotational speed of the second developer holder are a second rotational speed lower than the first rotational speed, the transport speed of the first developer transported by the first transport unit is a second transport speed lower than the first transport speed and the transport speed of the second developer transported by the second transport unit is higher than the second transport speed.
